(19) United States
(12) Patent Application Publication
(10) Pub. No.: US 2026/0079731 A1
(43) Pub. Date: Mar. 19, 2026

(54) METHODS AND SYSTEMS FOR DYNAMIC USER INTERFACE CREATION

(71) Applicant: Shopify Inc., Ottawa (CA)

(72) Inventors: Sergey Melnikov, Ottawa (CA); Jason Miller, Hamilton (CA); Craig Campbell Brunner, San Jose, CA (US)

(21) Appl. No.: 18/884,587

(22) Filed: Sep. 13, 2024

(51) Int. Cl. G06F 9/451; G06F 40/174

(52) U.S. Cl. CPC G06F 9/453; G06F 40/174

(57) ABSTRACT

A computer-implemented method including associating, at a resource having a plurality of task elements, a task element manifest with each task element from the plurality of task elements, thereby creating a resource map, receiving a request to complete a task; providing the request to complete the task and at least a portion of the resource map to a Large Language Model (LLM); and obtaining, from the LLM, a dynamic user interface to complete the task.

### FIELD OF THE DISCLOSURE

The present disclosure is related to user interfaces in computing systems, and in particular relates to dynamic user interfaces.

### BACKGROUND

User Interfaces (UIs) are typically hierarchical. Specifically, tasks are typically grouped under a tab, menu, or user interface block that then leads to other user interface blocks, such as sub-menus, new windows or tasks. Collectively these may be referred to herein as UI or task elements. With a traditional user interface (UI), elements are grouped together in a way that makes them easily discoverable within such hierarchy.

The problem with such structure, however, is that to complete some tasks a user may have to navigate to several screens or components that are far apart in the hierarchy. Specifically, to accomplish a task may require a user to navigate to a first appropriate UI block and provide input or otherwise manipulate such block, then navigate to a second appropriate UI block, and so on.

### SUMMARY

To overcome difficulties with tasks having diverse UI blocks, a task-oriented user interface may be created to accomplish a task. In such task-oriented UI, sets of screens to complete a certain task may be placed together. However, such groupings may hurt discoverability and may require manual curation of possible task flows ahead of time.

Historical ways to combine hierarchical and task-oriented UIs, such as the use of wizards, have resulted in poor discoverability, usability and maintainability issues.

Therefore, in accordance with the embodiments of the present disclosure, task elements may be wrapped with a manifest, which may contain metadata and properties for each task element. Specifically, the manifest may contain various information, including an indication of the resource the manifest is for; an indication of the loader to use for the task element; a list of children for the task element; metadata such as the scope of the element, the category of the element, a navigation path for the element, a description of the element, input metadata for the element, output metadata for the element, and keywords or terms for the element; eligibility or permissions used for the element, among other information.

Such metadata allows for the breaking down of a UI into a knowable action, which may include the input and output schema for that action.

Input metadata as used herein is the form schema and any parameters needed to provide enough context for that action. In the example of updating a product, the product ID may be needed to be able to act on the product, and the form schema may be needed to know what the current and malleable fields are.

The output schema provides knowledge of what will be generated as a result of the action so that multiple actions (inputs flowing to outputs) may be chained together.

An endpoint or callback function may also in some cases be needed to indicate where the business logic is for processing the action so that it can be performed from the generated UI (e.g. headless UI) and set up the generated UI to be able to post to the correct business logic to accomplish the action.

Such manifest may then be used to inform a Large Language Model (LLM) of what components are available and what tasks each component can perform. Such metadata and properties of the task elements may be used, via the output of the LLM, to generate and display a UI. In some cases, the UI may include a set of components typically used together, and in other cases it may generate a UI with a mix of components used to perform the specific set of tasks required to fulfill the user's intent.

Therefore, in one aspect, a computer-implemented method may be provided. The method may include associating, at a resource having a plurality of task elements, a task element manifest with each task element from the plurality of task elements, thereby creating a resource map. The method may further include receiving a request to complete a task and providing the request to complete the task and at least a portion of the resource map to a Large Language Model (LLM). The method may further include obtaining, from the LLM, a dynamic user interface to complete the task.

In some embodiments, the task element manifest may define hierarchical relationships between task elements.

In some embodiments, a task element from the plurality of task elements may be built using a loader associated with the task element as specified in the task element manifest for the task element.

In some embodiments, the method may further include training or fine-tuning the LLM using the task element manifest.

In some embodiments, the method may further include adding a new task element to the resource, the adding comprising adding a task element manifest for the new task element.

In some embodiments, the dynamic user interface may comprise forms used to complete the task.

In some embodiments, the forms may be pre-populated by the LLM with information to complete the task.

In some embodiments, the plurality of task elements may be user interface components on a web site.

In some embodiments, the method may further include causing the dynamic user interface to be rendered.

In some embodiments, the task element manifest may include at least one of: an indication of a loader to use for the task element; a list of children for the task element; a scope of the task element; a category for the task element; a navigation path for the task element; a description of the task element; keywords or terms for the task element; input metadata for the task element; output metadata for the task element; endpoint data for the task element; callback functions for the task element or eligibility or permissions used for the task element.

In a further aspect, a computing device having a processor, a memory and a communications subsystem may be provided. The computing device may be configured to associate, at a resource having a plurality of task elements, a task element manifest with each task element from the plurality of task elements, thereby creating a resource map. The computing device may further be configured to receive a request to complete a task and provide the request to complete the task and at least a portion of the resource map to a Large Language Model (LLM). The computing device may further be configured to obtain, from the LLM, a dynamic user interface to complete the task.

In some embodiments, the task element manifest may define hierarchical relationships between task elements.

In some embodiments, a task element from the plurality of task elements may be built using a loader associated with the task element as specified in the task element manifest for the task element.

In some embodiments, the computing device may further be configured to train or fine-tune the LLM using the task element manifest.

In some embodiments, the computing device may further be configured to add a new task element to the resource by adding a task element manifest for the new task element.

In some embodiments, the dynamic user interface may comprise forms used to complete the task.

In some embodiments, the forms may be pre-populated by the LLM with information to complete the task.

In some embodiments, the computing device may further be configured to cause the dynamic user interface to be rendered.

In some embodiments, the task element manifest may include at least one of: an indication of a loader to use for the task element; a list of children for the task element; a scope of the task element; a category for the task element; a navigation path for the task element; a description of the task element; keywords or terms for the task element; input metadata for the task element; output metadata for the task element; endpoint data for the task element; callback functions for the task element or eligibility or permissions used for the task element.

In a further aspect, a non-transitory computer readable medium for storing instruction code may be provided. The instruction code, when processed by a processor of a computing device, may cause the computing device to associate, at a resource having a plurality of task elements, a task element manifest with each task element from the plurality of task elements, thereby creating a resource map. The instruction code, when processed by a processor of the computing device may further cause the computing device to receive a request to complete a task and provide the request to complete the task and at least a portion of the resource map to a Large Language Model (LLM). The instruction code, when processed by a processor of the computing device may further cause the computing device to obtain, from the LLM, a dynamic user interface to complete the task.

### BRIEF DESCRIPTION OF THE DRAWINGS

The present disclosure will be better understood with reference to the drawings, in which:

FIG. 1A is a block diagram of a simplified convolutional neural network, which may be used in examples of the present disclosure.

FIG. 1B is a block diagram of a simplified transformer neural network, which may be used in examples of the present disclosure.

FIG. 2 is a block diagram of an example computing system, which may be used to implement examples of the present disclosure.

FIG. 3 is a block diagram showing an example tree layout for task elements in a user interface.

FIG. 4 is a process diagram showing steps and task elements used to complete an example task.

FIG. 5 is a block diagram showing an example task element manifest for use in association with a task element.

FIG. 6 is a dataflow diagram showing the use of a resource map created from task element manifests in association with questions to allow an Artificial Intelligence (AI) assistant to create a dynamic user interface.

FIG. 7 is a block diagram showing an example user interface used to complete a task.

FIG. 8 is a block diagram showing an example user interface showing a first page used to complete a task.

FIG. 9 is a block diagram showing an example user interface showing a second page used to complete a task.

FIG. 10 is a block diagram showing an example user interface showing a third page used to complete a task.

FIG. 11 is a block diagram showing an example user interface showing a fourth page used to complete a task.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

Hierarchical user interfaces may be cumbersome for accomplishing a task. For example, the task may require task elements from different parts of the user interface tree be executed. In some cases, such execution may need to be in a particular order. This may lead to frustration or the inability to complete the task for users not completely familiar with the user interface and the task elements therein.

One solution to this is to create a wizard for the completion of specific tasks. However, wizards are rigid for specific tasks, and such tasks must be determined and the wizard written for them. Further, such wizards need to be maintained, which may be time consuming for a UI that could change over time.

Therefore, in accordance with the embodiments of the present disclosure, task elements may be wrapped with a manifest, which may contain metadata and properties for each task element. These manifests create a static tree that becomes navigable (routable). The term task element may also be referred to as one or more actions, intents or actionable intents, among other options.

Such routable structure presents several advantages.

In prior solutions, routes are generally only defined at runtime, and may be dynamic, for example based on permissions. This is problematic when using tools such as Large Language Models to determine how to complete a task. Specifically, UI elements in the past were typically built for human interaction, requiring dynamic rendering. For an LLM, the model needs something to parse, and rendering each page takes significant resources, causes latency and delays, and is generally not performant.

With a static tree of task elements and manifests, a single source of truth is created. This may be referred to as a resource map. An LLM could know, using such manifests, what a form does, and in some cases the form can be preloaded and prefilled based on such metadata. This creates forms that are “headless”.

An optional additional step, the preloading or prefilling of a form may involve fetching the current value or set of available values for the current context in which the form is being used. In one example, a set of collections may exist, and the system will fetch these options dynamically at the time of use as metadata. In these cases, it is useful when asking the LLM to generate a new value to a certain field, to provide the current value of the field it is changing. In another example, while the field generated should be a string, there may only be an enumerated set of strings that are valid. For example, a seasonal string may be limited to values of “Summer”, “Fall”, “Winter” and “Spring”. Thus, in some cases, everything needed for a form may be in the manifest already. However, in some cases additional metadata or information may need to be fetched to enhance the manifest with current state/context before inputting it into the LLM.

Thus, the manifest, using the metadata and properties of the task elements, is used to inform the LLM (as part of the input via training, tuning or prompting) of what components are available and what tasks the component can perform.

Using such metadata and properties of the task elements allows the LLM to generate a UI, which may then be rendered on a computing device. In some cases, the UI may include a set of components typically used together, and in other cases it may generate a UI with a mix of components used to perform the specific set of tasks required to fulfill the user's intent.

In some cases, business logic is encapsulated in the manifest, allowing a chatbot/LLM to determine what to do, and to build the UI to do the action. This may involve defining endpoints or callback functions to retrieve or submit data. Essentially there may be business logic in the manifest, or a pointer or address used to fetch the business logic.

In some cases, Route Manifests and Loaders may be used as the underlying technology, though these may be annotated in a way that can be used by the LLM/AI. Additionally forms and form elements may be created with annotations that will be used by the LLM/AI both as input to provide understanding, and as output to generate form input.

Route Manifests have hierarchy. Instead of pulling in a single form element (an input box), the whole form as a set may be pulled in—or even higher in the hierarchy a whole widget that contains a form and multiple elements within the form and outside the form may be pulled in.

An LLM can use information about the task elements to create a response to a question in a chatbot. For example, forms and form elements may have manifests which can be used as input to the LLM to provide understanding of what can be done with the form or form element. The LLM may output a form, form element or sets of form elements as well as values to set them to. This may involve displaying the form element with the value as part of a rendered page for the user to submit, or fully submitting the set form to the system. In other words, the LLM output may be a UI with a filled form and/or may output an action to be performed on a task element.

For example, instead of or in addition to outputting code to cause something to be displayed as a UI, the LLM may output an action such as a headless action to act on the form. These actions, such as submitting the set form may further be chained together where multiple forms are filled and submitted in sequence.

In either the display or headless action case, the system may also be improved by having an output schema which describes the shape that the form should be generated in. This enables the system to retry if the output does not match such output schema on the first try, or display an error rather than an incorrect UI or action.

Such system may be used in various settings. For example, a Software as a Service (SaaS) platform such as one offering website hosting services may allow users the ability to converse with an Artificial Intelligence (AI) powered assistant. In some cases, the user may, among other possible actions, ask the AI assistant to perform a task. To complete the performance of the task, the assistant may be supplied with the at least a portion of the resource map.

The LLM can then use such resource map information and task information to create a dynamic user interface to complete the task.

### Machine Learning and Computing Device

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publically-available text corpuses may be, e.g., fine-tuned by further training using the complete works of Shakespeare as training data samples (e.g., where the intended use of the ML model is generating a scene of a play or other textual content in the style of Shakespeare).

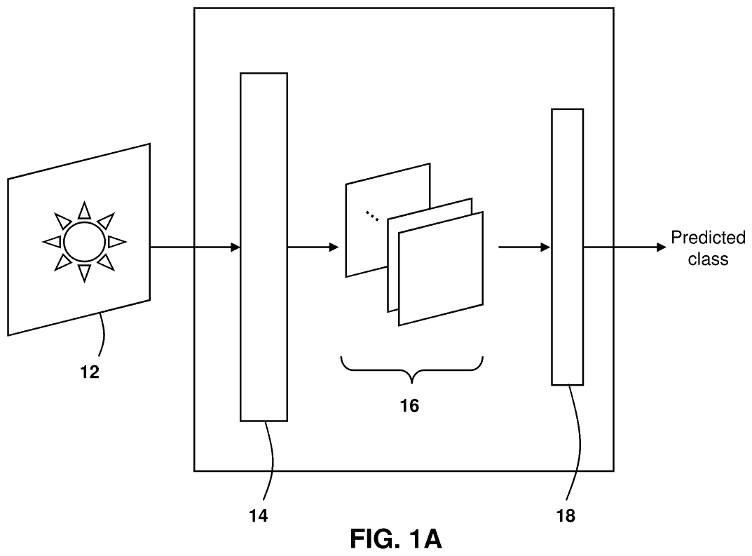

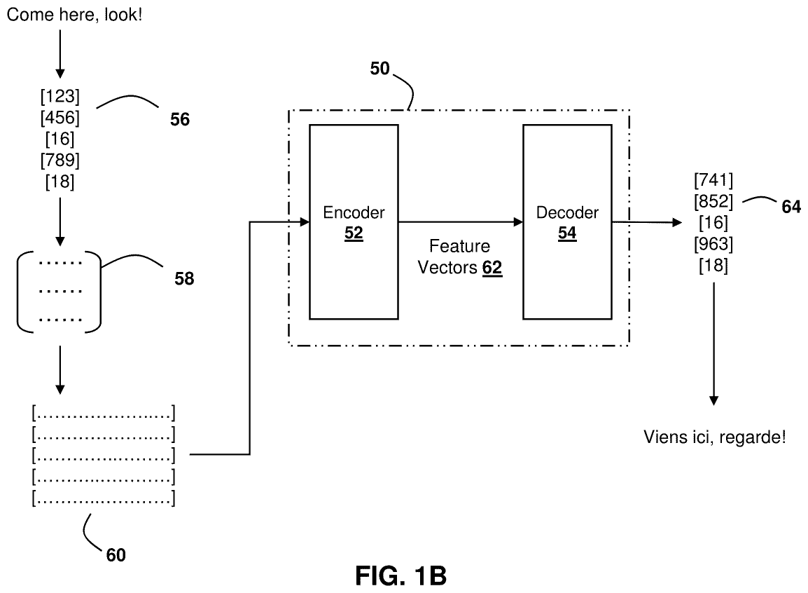

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), an End Of Text [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

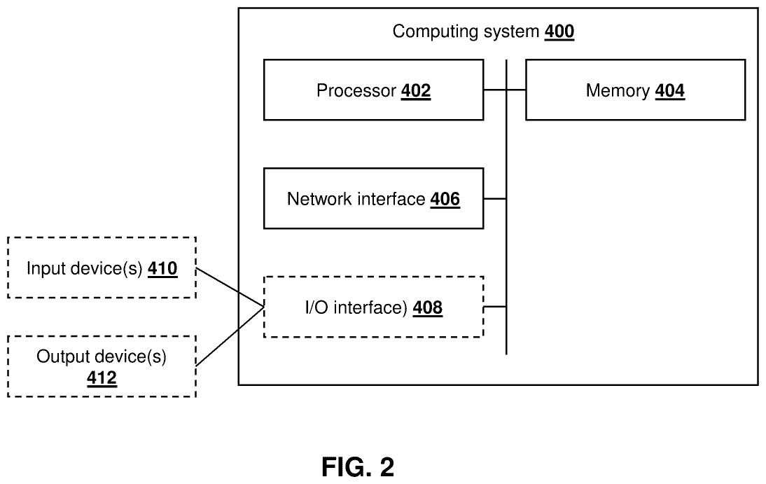

FIG. 2 illustrates an example computing system 400, which may be used to implement examples of the present disclosure, such as a prompt generation engine to generate prompts to be provided as input to a language model such as an LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a Person to Person (P2P) network, a Wide Area Network (WAN) and/or a Local Area Network (LAN)). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### Hierarchical User Interface

A typical user interface may be hierarchical in nature. For example, on a web page, a landing page may have a plurality of UI elements such as menus, links, forms or other elements which allow interaction with the website. Clicking through the menu, links, forms, or other such elements can lead to further pages or task elements having other menu items, links, forms or other elements.

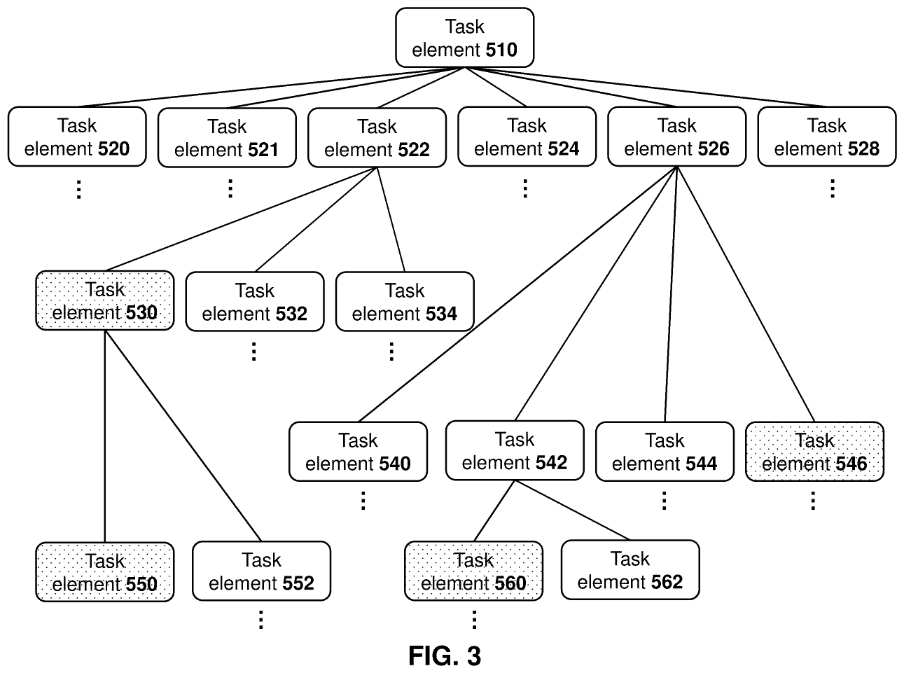

For example, reference is now made to FIG. 3. In the example of FIG. 3, a task element 510 may be an initial starting point on a user interface, for example the home screen of a web page. Task element 510 may have interactive UI components which may lead to a plurality of task elements therein, allowing the user to navigate through the user interface. For example, a menu or links on a webpage may allow a user to navigate to other pages, forms, content, sections, sidebars, widgets, among other options, collectively referred to herein as a task element. Thus, from task element 510, a plurality of task elements, labeled as task element 520, task element 521, task element 522, task element 524, task element 526 and task element 528 may be reached.

In many cases, each of such task elements may lead to other task elements within their structure. FIG. 3 is simplified to only show examples of some sub-task elements. For example, task element 522 is shown leading to task elements 530, 532 and 534.

Similarly, task element 526 is shown leading to task elements 540, 542, 544, and 546.

Following with the tree structure, such task elements can further have other task elements that they lead to. For example, task element 530 can lead to task elements 550 and 552. Task element 542 can lead to task elements 560 and 562 in the example of FIG. 3.

However, the example of FIG. 3 is merely provided for illustration showing a tree with a plurality of task elements and the structure of the tree is simplified. In practice, the structure of the tree may have different task elements, may be wider or narrower, may be deeper or shallower, may have links back to other task elements within the tree structure, thereby creating circular loops, among other options.

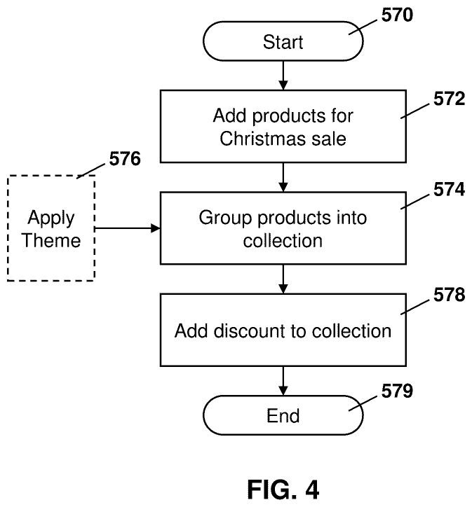

As provided above, the use of a hierarchical UI such as the UI of FIG. 3 can be cumbersome to accomplish a task. To illustrate this, one non-limiting example may the creation of a Christmas display in an electronic storefront, as shown in FIG. 4. Specifically, on an electronic commerce platform having a plurality of electronic storefronts, an administrator of such storefront may wish to have a Christmas display. Normally this would involve going to a products creation page or form from a menu, creating the products for the Christmas sale, then going to a collections page to add the products to the collection, going to a discounts area to create a discount for the products, as well as changing text and the look of the page to a holiday theme.

Thus, in the example of FIG. 4, the process starts at block 570 and proceeds to block 572 in which a user navigates to a UI element to add products that will be sold for the Christmas sale.

From block 572, the process proceeds to block 574 in which the administrator may then navigate to a collections page to group products into a collection for the Christmas display. Optionally, the administrator may also need to navigate to a theme or display page, shown at block 576, to apply a theme to the collection.

From block 574, the process proceeds to block 578 in which the administrator may need to navigate to a price administration page in order to add a discount to the collection. For example, there may be a “create discount code” widget (optionally pre-filled with a connection to the Christmas Sale collection in block 574).

The process then proceeds to block 579 and ends.

In the traditional hierarchical UI of FIG. 3, each task element to accomplish the tasks of FIG. 4 may be in different locations. Thus, for example, products may be added using task element 560. Products may be grouped into collections using task element 550. The theme or appearance of collections may be administered in task element 530. Sales or discounts for collections may be administered through task element 546.

As will be appreciated by those in the art, a user or administrator unfamiliar with the layout of the user interface may have difficulty navigating between the various task elements in order to accomplish the task.

Thus, in accordance with the embodiments of the present disclosure, dynamic user interfaces to accomplish a task may be generated through the use of artificial intelligence or large language model tools. To facilitate the generation of such dynamic user interfaces, the various task elements within the user interface may be wrapped with a manifest providing details for the task element, including metadata about the task element, a hierarchical structure for the task element, eligibility or permissions used for the element, and/or loaders for use with the task element. The UI may have a plurality of such task elements, each with an associated task element manifest, where the plurality of associated task element manifests creates a resource map for the page or user interface.

### Task Element Manifests

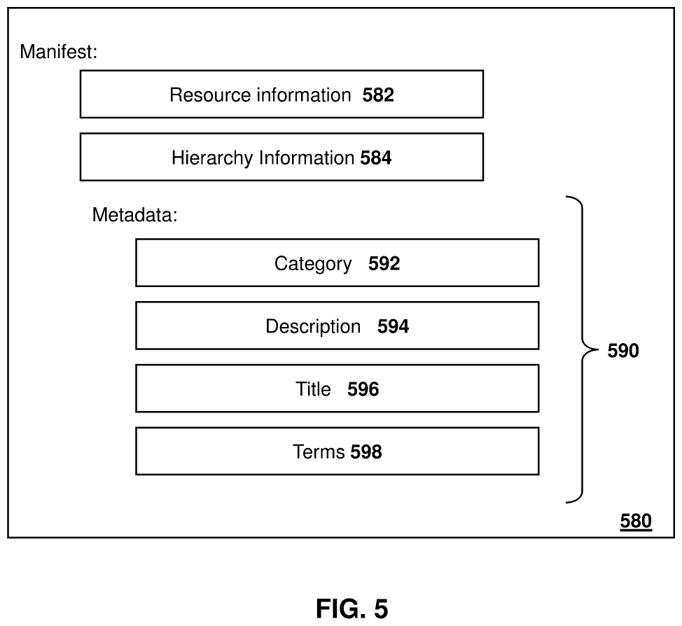

Task element manifests are now described with regards to non-limiting examples. In particular, reference is made to FIG. 5, which shows one example manifest 580. However, the manifest 580 of FIG. 5 is merely provided for illustration, and in some cases the components of manifest 580 may include only a subset of the elements described therein. In other cases, additional elements may be provided as part of the manifest.

In the example of FIG. 5, manifest 580 may include resource information, as shown at block 582. Resource information may include, for example, loaders that could be used to render the task element associated with manifest 580. Resource information may include permissions for the use of the task element associated with manifest 580. Resource information may include whether the manifest can be indexed or not. Resource information may include navigation paths to the component or task element itself. Resource information could include a scope for the task element. Resource information may include input metadata for the element, such as form schema and parameters to provide context for an action. Resource information may include output metadata for the element, such as information or results of the task element to enable the task element to be chained together with other task elements. Resource information may include endpoint or call back functions to allow the system to know where business logic is for processing an action using the task element. Other resource information could similarly be grouped within block 582.

Further, in some cases manifest 580 may include hierarchy information, as shown with block 584. In some cases, hierarchy information may simply hold information about children. Thus, in one case the manifest 580 could hold metadata about its task element, and information about its children. The children may each have their own manifest holding metadata about such child task element.

In some cases, the hierarchy information at block 584 may include information about the parent(s) of the present task element.

Thus, the metadata held in a task element manifest 580 may be hierarchical.

Task element manifest 580 may further include metadata 590 about the task element. Metadata 590 may include various information, and in the example of FIG. 5 includes category block 592, description block 594, title block 596, and terms or keywords block 598. However, in practice, the metadata may include more or less information, may be grouped or combined in different ways, and thus the example of FIG. 5 is provided for illustration only.

Category information at block 592 may include, for example, whether the task element relates to products or services. In some cases, the category may be related to particular products—for example sporting goods or kitchen wares. Other options for categories are possible.

A description block 594 may contain a plain language description of the functions and purpose of the task element. In some cases, description block 594 may encapsulate business logic to facilitate a chatbot/LLM to infer or deduce what to do and build the UI to do the action.

A title block 596 may provide a title or label for the task element.

A terms block 598 may provide for keywords or terms that could be relevant to the task element.

For example, one simplified manifest is shown in Table 1 below.

TABLE 1
Example Manifest

```
const routeManifest = {
  resource: ‘collection’,
  actionType: ‘list’,
  id: ‘collection:list’,
  loader: ‘./loader.ts',
  url: ‘’,
  index: true,
  children: [ array of children ],
  parents: [ array of parent(s) ],
  metadata: {
    search: {
      scope: ‘shop’,
      category: ‘products',
      navigationPath: [ ],
      description: ‘View, create and update collections to organize
        products by category’,
      title: ‘Collections List’,
      terms: [
        ‘collection’,
        ‘collections',
        ‘view collections',
        ‘list collections',
        ‘categories',
        ‘category’,
        ‘group products,
        ‘gallery’,
        ‘product gallery’,
        ‘automated collection’,
        ‘smart collection’,
        ‘manual collection,
        ‘product group’,
        ‘product groupings',
        ‘grouping products',
      ],
    }
  }
};
```

Thus, as seen in Table 1, the manifest includes routing information, hierarchical information, a description of the task element, terms or keywords used for the task element, and other similar metadata.

For manifest 580, in some cases, Route Manifests created by Blitz™ and Loaders created by React Router™ may be used as the underlying technology, though these may be annotated in a way that can be used by the LLM/AI. Additionally forms and form elements may be created with annotations that will be used by the LLM/AI both as input to provide understanding, and as output to generate form input.

Route Manifests have hierarchy. Instead of pulling in a single form element (an input box), the whole form as a set may be pulled in—or even higher in the hierarchy a whole widget that contains a form and multiple elements within the form and outside the form may be pulled in.

Forms and form elements may have additional annotations which can be used as input to the LLM to provide understanding of what can be done with the form or form element.

Rendering of Task Elements using Manifests

The use of a resource map comprising a plurality of task element manifests provides certain advantages to an AI/LLM. Specifically, such structure creates a static tree that becomes navigable (routable).

In prior solutions, routes are generally only defined at runtime, and may be dynamic, for example based on permissions. This is problematic when using tools such as Large Language Models to determine how to complete a task. Specifically, UI elements in the past were typically built for human interaction, requiring dynamic rendering. For an LLM, the model needs something to parse, and rendering each page takes significant resources, causes latency and delays, and is generally not performant.

With a static tree of task elements and manifests, a single source of truth is created, referred to as a resource map.

Use of Metadata with Task Elements for Task Completion

An LLM can use information about the task elements to create a response to a question in a chatbot. For example, forms and form elements may have manifests which can be used as input to the LLM to provide understanding of what can be done with the form or form element. The LLM may output a form, form element or sets of form elements as well as values to set them to. This may involve displaying the form element with the value as part of a rendered page for the user to submit, or fully submitting the set form to the system.

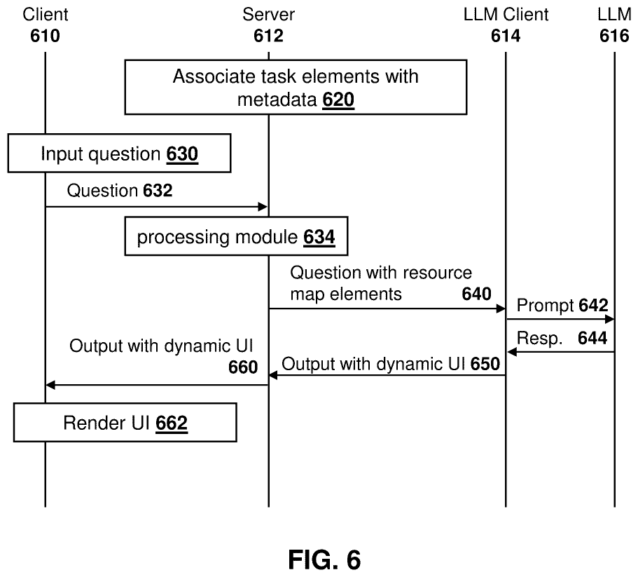

For example, reference is now made to FIG. 6. In the example of FIG. 6, a client 610 may be any computing device capable of interacting with a computing network, and could include a personal computer, laptop, tablet, mobile device, among others. In some cases, client 610 may run a web client such as a browser which may be used to interact with a system run on a server 612.

Server 612 may provide a service such as a software as a service (Saas) platform in some cases. For example, such server may be used for an e-commerce platform. While server 612 is shown as a single computing device in the example of FIG. 6, in practice, server 612 may comprise a plurality of computing devices, and the illustration of a single server is provided for simplicity.

Further, in some cases client 610 may be capable of communicating directly with the LLM client 614, in which case, the functionality illustrated in FIG. 6 and associated with server 612 may be placed onto client 610.

Other examples are possible.

LLM client 614 is a piece of software directly making the calls to the LLM 616. Specifically, typically an LLM 616 will not be reachable except though an LLM client 614.

However, if the LLM 616 is directly reachable, then LLM client 614 is optional.

In the example of FIG. 6, a server 612 may have a resource map stored therein, as shown at block 620, which associates task elements with metadata, as described above, for example with regards to FIG. 5. Further, as task elements are added to a site, a manifest for such new task element can be created. In some cases, the manifest can have specific structure and keywords to allow it to be interoperable with the remaining task elements. This could be used to update the resource map stored at server 612, as well as for training and/or fine tuning the LLM 616.

Thereafter, a user may use client 610, for example using a user interface, to input a question at block 630.

The client 610 may then forward the question in message 632 to server 612.

In some embodiments, server 612 may optionally include a processing module 634 that can find a relevant portion of the resource map for the question. Specifically, in some cases the resource map may be larger than allowed to be provided to an LLM prompt, and thus server 612 may need to limit the prompt to portions of the resource map. Thus, in some cases, a portion of the resource map may be found based on the question from the client 610. For example, a partial hierarchy or selected manifests can be created to be provided to the LLM via a retrieval augmented generation (RAG) system in some cases. A partial hierarchy or selected manifests can be created to be provided to the LLM as few-shot examples in a prompt. Other options for processing the resource map are possible.

Server 612 may then provide the question with at least a portion of the resource map in message 640 to LLM client 614. As it will be appreciated, if the resource map is small enough to send to the LLM client 614, message 640 may in some cases contain the entire resource map. In this case, processing module 634 may be omitted.

However, even if the resource map is small enough to provide entirely to the LLM client, in some cases processing module 634 may still be used to reduce the amount of data that is provided to the LLM client, for example to improve performance, reduce latency, or for other reasons.

If server 612 is not part of the system, message 640 may be created and sent directly from the client 610 to the LLM client 614.

LLM client 614 may receive message 640 and may then create a prompt 642 to send to the LLM 616.

LLM 616 processes the question and the data in the prompt and provides a response 644 back to the LLM client 614. Such processing may use the metadata in the resource map to break down the UI into knowable actions and use such knowable actions, with input and output schemas, also with endpoint or call back functions, to generate a dynamic UI and/or actions for client 610.

LLM client 614 may then provide the output with a dynamic user interface to complete the task to the server 612 in message 650. In some cases, rather than or in addition to the dynamic user interface, message 650 may include one or more actions to be performed at server 612 or client 610, Specifically, the LLM may identify how a task can be completed, an order of steps needed to complete the task, the task elements needed to complete each step, among other information, and may create a dynamic user interface with such task elements. In some cases, data that is needed for task elements may be pre-populated in the dynamic UI when such data is available.

The identification of the task elements is made possible by the resource map having the “headless” task elements and metadata associated therewith, thereby allowing the LLM to process the available resources without the need to render each element in the tree.

The dynamic user interface may comprise various forms needed to be completed to complete the desired task. In some cases such forms may be pre-populated with information known to the system.

Server 612 may provide the output with the encoded structured data back to the client 610 in message 660. In some cases, message 660 may further include instructions for client 610 to render the dynamic UI, or other actions. In other cases, receipt of message 660 may cause client 610 to render the UI. In both cases, the rendering of the UI is shown with block 662. In some cases, the rendering may also use endpoint or call back functions embedded in the output from the LLM to allow actions to be performed from the generated UI.

As will be appreciated by those skilled in the art, if server 612 is not part of the system, then the LLM client 614 may send message 650 directly to client 610.

### Use in an E-Commerce Platform

In one non-limiting example, the systems and methods of the present disclosure may be used with regard to an e-commerce platform. For example, as provided above with regard to FIG. 4, an administrator of an electronic storefront may wish to create a Christmas display for the storefront. Thus, the task in this case is the creation of the Christmas display, which requires the administrator to create any new products needed in the system first, and then create the collection of products (new or old or a combination thereof) for such display. Discounts may be applied, and themes may be applied. In the system of FIG. 3 this required the administrator to know where to go in the UI to accomplish each step, and the steps may need to be performed in order.

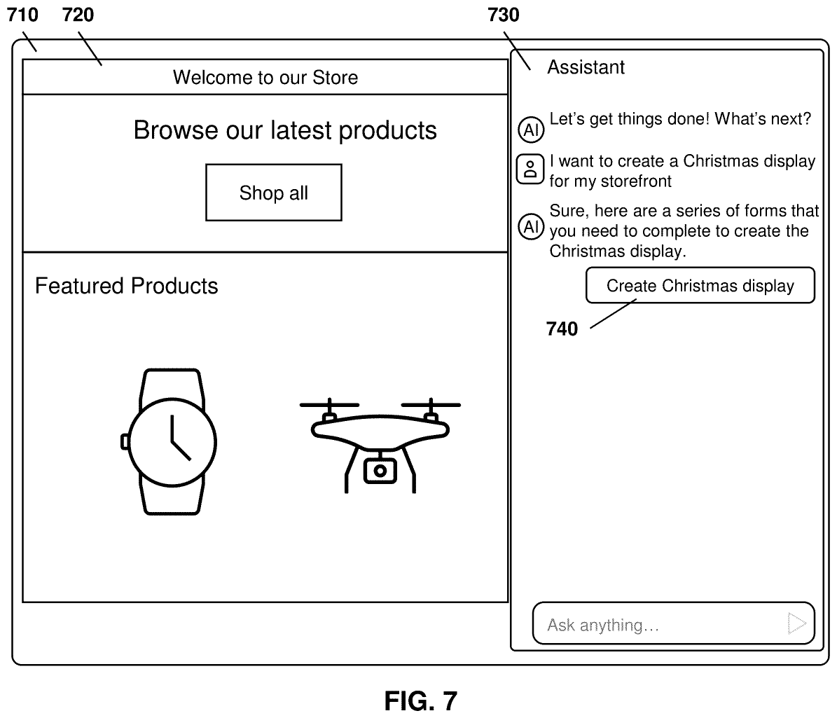

Conversely, reference is now made to FIG. 7, which shows a web page 710 that may represent an administrative portal of a electronic storefront. In some cases, such portal may provide an AI assistant 730 to assist a user or administrator of the site to accomplish tasks. The web page in this case may display an administrative page or mock-up of the storefront in a display 720.

In the example of FIG. 7, a user asks the AI assistant to create a Christmas display for the storefront.

In order for the AI assistant to be able to create the Christmas display, details of the resource map, including the metadata, hierarchy, and/or loaders may be provided to the LLM. Metadata may include business logic in some cases. Metadata may include input schema in some cases. Metadata may include output schema in some cases. In some cases, training of the LLM may include functionality that storefront administrators have performed in the past, and this may assist the LLM decide what needs to be done. Further, training, metadata and/or business logic may dictate an order for tasks to be performed to complete the request, and the input and output schema may allow such tasks to be chained together.

In some cases, the LLM may provide information in a link to dynamically render the task elements, shown with link 740. However, in other cases the display 720 may automatically display the dynamic UI upon the request being submitted to the AI assistant. Other options are possible.

Upon clicking on a link 740 or upon asking the question, the LLM could create a dynamic user interface which may be rendered. In some cases, all the task elements to complete the task could be rendered in a single UI screen. In other cases, various task elements could be linked together, for example through buttons or links. Other options for the dynamic user interface are possible.

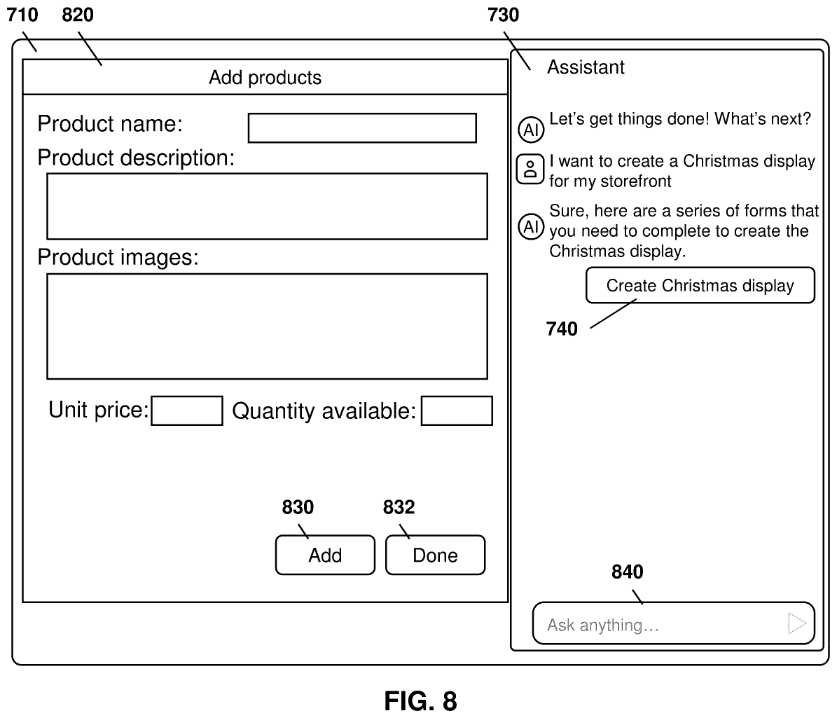

For example, reference is now made to FIG. 8 which shows a first screen for completing the task of creating the Christmas display. In this case, page 820 could be an add products page, and could include button 830 to add the product (and then potentially allow the adding of further products) and button 832 to move to the next step. As will be appreciated by those in the art, the user interface of FIG. 8 is simplified and in practice more sophisticated user interfaces would likely be used.

In some cases, the UI assistant, through input box 840, could be used to assist in the addition of products. For example, the user or administrator could ask the AI assistant to add a sled and the AI assistant could fill in the product name, product description and other fields within the form on page 820.

In some cases, some fields on page 820 may be prepopulated, depending on data known to the AI assistant 730.

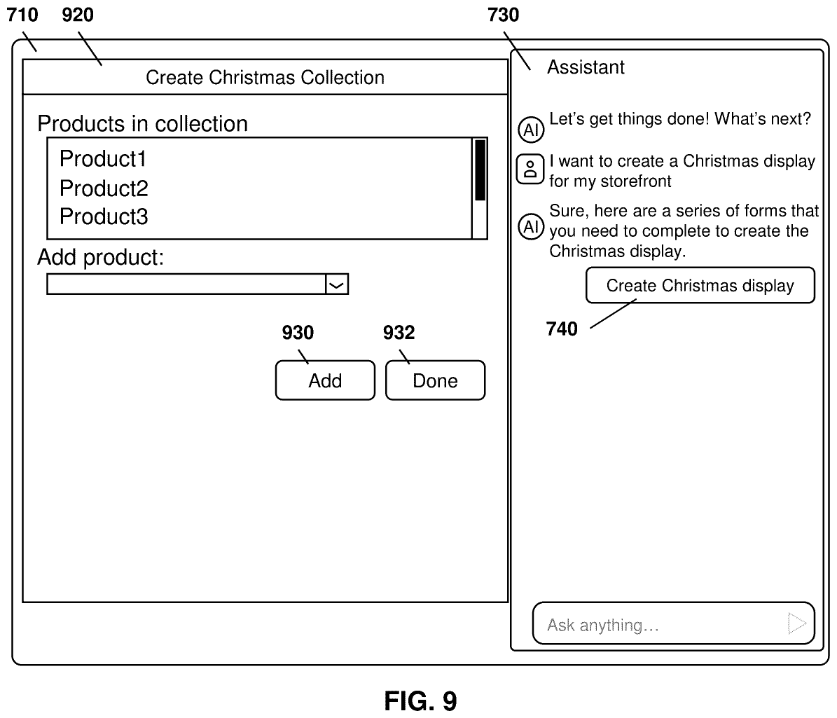

Once the user is finished adding products, the user could push the done button 832. Based on the dynamic UI, this could be linked to the next task element(s) used to complete the task, an example of which is shown with regard to FIG. 9.

FIG. 9 shows an example second screen for completing the task of creating the Christmas display. In this case, page 920 could be a page to create a collection for the display, and could include button 930 to add a product from a dropdown list of products, and button 932 to move to the next step. As will be appreciated by those in the art, the user interface of FIG. 9 is simplified and in practice more sophisticated user interfaces would likely be used.

In this case, the collection may be prepopulated with any products created on page 820, for example.

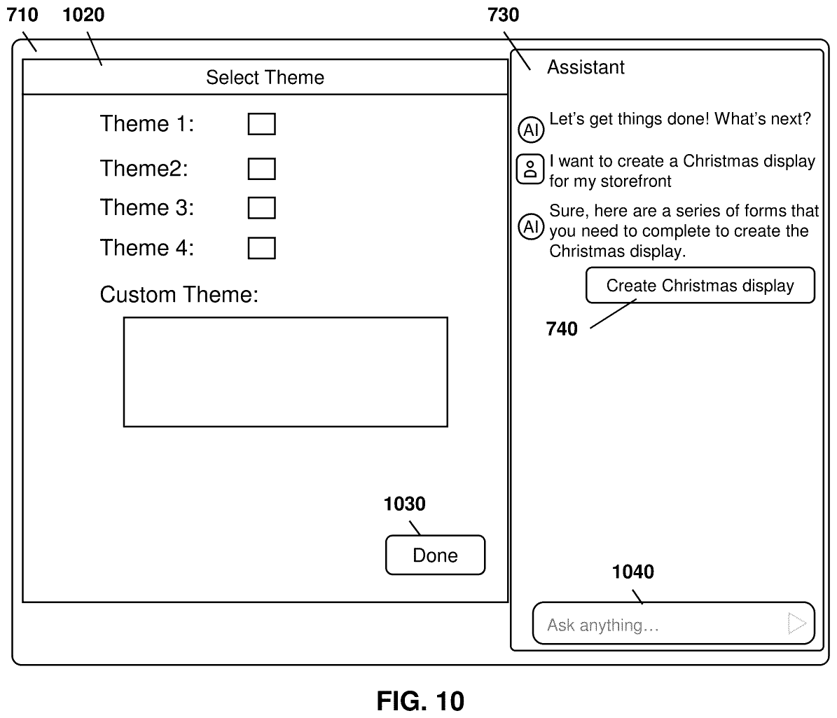

Once the user presses the done button 932, the UI may render page 1020 of FIG. 10, which may be used to add a theme. In this case, the AI assistant may be used to assist in the creation of a custom theme, for example by using input box 1040.

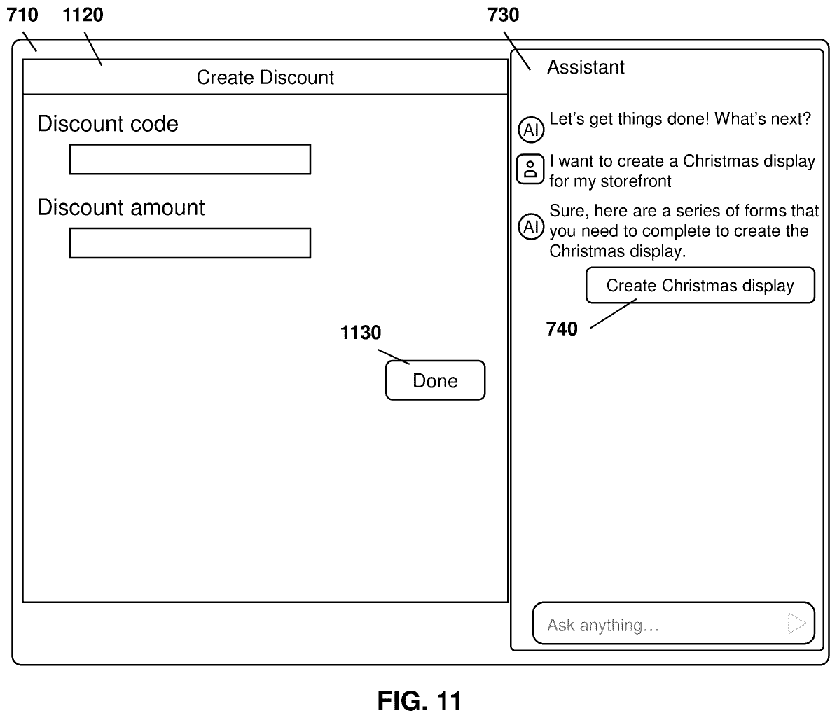

Once the user is satisfied with the theme, the user could push a button 1030 to move to the next section, shown with FIG. 11. In the example of FIG. 11, a user could use page 1120 to input discount codes and discount amounts for the collection and could use button 1130 to indicate that the task is completed.

As this is the last task element, the dynamic UI could in some cases use the information to create a mock-up of the new Christmas display, or could publish the display, or ask the user whether to publish the new display, among other options.

Thus the LLM may be provided with a portion of a resource map containing task elements wrapped with manifest data. The LLM can use such resources to create a dynamic user interface to accomplish a requested task, where the dynamic user interface could include forms that are loaded and, in some cases, pre-filled for each step used to complete the task. The LLM may, using the resources, know which forms/fields are used and what should be input, changed or validated to complete the task.

Training In some cases, the LLM can be trained or fine tuned using the resource map.

This may further utilize information about the tasks/actions that administrators have performed in the past, along with the steps used to accomplish those tasks. For example, the LLM could, in a training phase, be taught with historic data. Feedback could be provided to the LLM in such training phase.

Further, feedback for the LLM could be provided back based on surveys of users trying to accomplish tasks, which could then be used for further training.

The combination of such resource map with metadata, business logic, historic manual interactions, could enable the AI assistant to be trained to assist in future tasks.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method comprising:
associating, at a resource having a plurality of task elements, a task element manifest with each task element from the plurality of task elements, thereby creating a resource map;
receiving a request to complete a task;
providing the request to complete the task and at least a portion of the resource map to a Large Language Model (LLM); and
obtaining, from the LLM, a dynamic user interface to complete the task.

2. The method of claim 1, wherein the task element manifest defines hierarchical relationships between task elements.

3. The method of claim 1, wherein a task element from the plurality of task elements is built using a loader associated with the task element as specified in the task element manifest for the task element.

4. The method of claim 1, further comprising training or fine-tuning the LLM using the task element manifest.

5. The method of claim 1, further comprising:
adding a new task element to the resource, the adding comprising adding a task element manifest for the new task element.

6. The method of claim 1, wherein the dynamic user interface comprises forms used to complete the task.

7. The method of claim 6, wherein the forms are pre-populated by the LLM with information to complete the task.

8. The method of claim 1, wherein the plurality of task elements are user interface components on a web site.

9. The method of claim 1, further comprising:
causing the dynamic user interface to be rendered.

10. The method of claim 1, wherein the task element manifest includes at least one of: an indication of a loader to use for the task element; a list of children for the task element; a scope of the task element; a category for the task element; a navigation path for the task element; a description of the task element; keywords or terms for the task element; input metadata for the task element; output metadata for the task element; endpoint data for the task element; callback functions for the task element; or eligibility or permissions used for the task element.

11. A computing device comprising:
a processor;
a memory; and
a communications subsystem,
wherein the computing device is configured to:
associate, at a resource having a plurality of task elements, a task element manifest with each task element from the plurality of task elements, thereby creating a resource map;
receive a request to complete a task;
provide the request to complete the task and at least a portion of the resource map to a Large Language Model (LLM); and
obtain, from the LLM, a dynamic user interface to complete the task.

12. The computing device of claim 11, wherein the task element manifest defines hierarchical relationships between task elements.

13. The computing device of claim 11, wherein a task element from the plurality of the task elements is built using a loader associated with the task element as specified in the task element manifest for the task element.

14. The computing device of claim 11, wherein the computing device is further configured to train or fine-tune the LLM using the task element manifest.

15. The computing device of claim 11, wherein the computing device is further configured to:
add a new task element to the resource by adding a task element manifest for the new task element.

16. The computing device of claim 11, wherein the dynamic user interface comprises forms used to complete the task.

17. The computing device of claim 16, wherein the forms are pre-populated by the LLM with information to complete the task.

18. The computing device of claim 11, wherein the computing device is further configured to:
cause the dynamic user interface to be rendered.

19. The computing device of claim 11, wherein the task element manifest includes at least one of: an indication of a loader to use for the task element; a list of children for the task element; a scope of the task element; a category for the task element; a navigation path for the task element; a description of the task element; keywords or terms for the task element; input metadata for the task element; output metadata for the task element; endpoint data for the task element; callback functions for the task element; or eligibility or permissions used for the task element.

20. A non-transitory computer readable medium for storing instruction code that, when processed by a processor of a computing device, cause the computing device to:
associate, at a resource having a plurality of task elements, a task element manifest with each task element from the plurality of task elements, thereby creating a resource map;
receive a request to complete a task;
provide the request to complete the task and at least a portion of the resource map to a Large Language Model (LLM); and
obtain, from the LLM, a dynamic user interface to complete the task.
